(19) United States
(12) Patent Application Publication
(10) Pub. No.: US 2015/0321539 A1
(43) Pub. Date: Nov. 12, 2015

(54) AUXILIARY SUBCOOLING CIRCUIT FOR A TRANSPORT REFRIGERATION SYSTEM

(71) Applicant: THERMO KING CORPORATION, Minneapolis, MN (US)

(72) Inventors: William Francis MOHS, Apple Valley, MN (US); Panayu Robert SRICHAI, Minneapolis, MN (US); William Leo WALDSCHMIDT, Randolph, MN (US); Robert Michael LATTIN, Minneapolis, MN (US)

(21) Appl. No.: 14/647,352

(22) PCT Filed: Nov. 26, 2013
(86) PCT No.: PCT/US2013/071945

§ 371 Date: May 26, 2015

Related U.S. Application Data
(60) Provisional application No. 61/729,724, filed on Nov. 26, 2012.

(51) Int. Cl. B60H 1/32; B60P 3/20; B60H 1/00

(52) U.S. Cl. CPC B60H 1/3208; B60H 1/00014; B60H 1/3222; B60H 1/3232; B60P 3/20; B60H 2001/3289

(57) ABSTRACT

An auxiliary subcooling circuit for a transport refrigeration system (TRS) is provided. The auxiliary subcooling circuit may be configured to be driven by a compressor that is separate from a main compressor of a main refrigeration system of the TRS. The auxiliary subcooling circuit can be configured to subcool refrigerant in the main refrigeration system. The auxiliary subcooling circuit and the main refrigeration system may be configured to be driven by a prime mover of the TRS. An engaging device is configured to allow the auxiliary subcooling circuit to engage or disengage the prime mover. Methods to control the TRS are also provided.

### FIELD OF TECHNOLOGY

Embodiments disclosed herein relate generally to a refrigeration system, such as a transport refrigeration system (TRS). More specifically, embodiments disclosed herein relate to an auxiliary subcooling circuit for the TRS.

### BACKGROUND

A refrigeration system, such as a TRS, typically includes a refrigeration unit. A transport refrigeration unit (TRU) for a TRS typically includes a condenser, an evaporator, a compressor and an expansion device forming a refrigeration circuit. In a cooling mode, generally, gaseous refrigerant is compressed by the compressor, and then condensed into liquid refrigerant in the condenser. The liquid refrigerant is expanded into a two-phase refrigerant by the expansion device, and then directed into the evaporator. The evaporator of the TRS may be configured to exchange heat, for example, with an interior space of a transport container, so that a temperature of the interior space of the transport container can be controlled.

The TRU may also incorporate other types of refrigeration systems, such as, for example, adsorption refrigeration systems, thermal storage (such as ice) refrigeration systems, refrigeration systems utilizing Peltier devices, etc.

### SUMMARY

A TRS equipped with an auxiliary subcooling circuit is provided. The auxiliary subcooling circuit may be coupled to a main refrigeration system of the TRS. The auxiliary subcooling circuit may help the main refrigeration system to achieve a lower freezing temperature, increase main refrigeration capacity, and/or increase efficiency of the main refrigeration system.

In some embodiments, the auxiliary subcooling circuit may be configured to have an auxiliary compressor, an auxiliary expansion device and an auxiliary subcooling heat exchanger, which are separate from a main compressor, a main condenser and a main expansion device of the main refrigeration system. In some embodiments, the auxiliary subcooling heat exchanger is configured to be coupled to the main refrigeration system. In some embodiments, the auxiliary subcooling heat exchanger is configured to subcool refrigerant in the main refrigeration system before the refrigerant flows into the main expansion device.

In some embodiments, the auxiliary subcooling circuit can include a flash tank, in which the refrigerant expanded by the auxiliary expansion device can be mixed with the refrigerant of the main refrigeration system so as to subcool the refrigerant of the main refrigeration system.

In some embodiments, the TRS may be configured to have a prime mover. In some embodiments, the prime mover may be configured to drive both the main refrigeration system and the auxiliary subcooling circuit. In some embodiments, the auxiliary subcooling circuit is coupled to the prime mover via an engaging device. In some embodiments, the engaging device may be configured to allow the auxiliary subcooling circuit to engage or disengage the prime mover, for example, on demand.

In some embodiments, a method to control the TRS may include when the demand of the main refrigeration system is low, preventing the auxiliary subcooling circuit from engaging the prime mover. In some embodiments, the method to control the TRS may include when the demand of the main refrigeration system is high, permitting the auxiliary subcooling circuit to engage the prime mover.

In some embodiments, the method to control the TRS may include when the prime mover has power available to drive the auxiliary subcooling circuit, allowing the auxiliary subcooling circuit to engage the prime mover. In some embodiments, the method to control the TRS may include when the prime mover does not have power available to drive the auxiliary subcooling circuit, preventing the auxiliary subcooling circuit from engaging the prime mover or disengaging the auxiliary subcooling circuit from the prime mover.

Other features and aspects of the fluid management approaches will become apparent by consideration of the following detailed description and accompanying drawings.

### BRIEF DESCRIPTION OF THE DRAWINGS

Reference is now made to the drawings in which like reference numbers represent corresponding parts throughout.

FIG. 1 illustrates a truck equipped with a TRS.

FIG. 2 illustrates a schematic diagram of an embodiment of a TRS including a main refrigeration system and an auxiliary subcooling circuit that is coupled to the main refrigeration system. The main refrigeration system and the auxiliary subcooling circuit have separate circuits.

FIGS. 3A and 3B illustrate two schematic diagrams of other embodiments of a TRS, which include a main refrigeration system and an auxiliary subcooling circuit that is coupled to the main refrigeration system. FIG. 3A illustrates an embodiment in which the auxiliary subcooling circuit is coupled to the main refrigeration system via an auxiliary subcooling heat exchanger. FIG. 3B illustrates an embodiment in which the auxiliary subcooling circuit is coupled to the main refrigerating system via a flash tank.

FIGS. 4A to 4C illustrate three embodiments, in which a prime mover is shared by a main compressor and an auxiliary compressor.

FIGS. 5A and 5B illustrate one exemplary method to control a TRS including a main refrigeration system and an auxiliary subcooling circuit. FIG. 5A illustrates a flow chart of the method. FIG. 5B illustrates a power demand/return air temperature chart that can be used in the method as illustrated in FIG. 5A.

### DETAILED DESCRIPTION

A typical mechanical TRS, similar to other conventional mechanical refrigeration systems, may include a compressor, a condenser, an evaporator and an expansion device. The expansion device is typically configured to expand liquid refrigerant from a condenser to two-phase refrigerant before the refrigerant enters the evaporator. The expansion device can be, for example, an expansion valve, a linear valve, an orifice, an expander, etc. A temperature of the liquid refrigerant entering the expansion device may be further reduced (or subcooled) by, for example, a subcooler. Reducing the temperature of the liquid refrigerant getting into the expansion device may help increase efficiency and/or a capacity of the evaporator and the refrigeration circuit. Further, reducing a temperature of the liquid refrigerant getting into the expansion device may help the evaporator achieve, for example, a lower freezing temperature.

In the description herein, embodiments of an auxiliary subcooling circuit driven by an auxiliary compressor that is separate from a main compressor of a main refrigeration system are described. The auxiliary subcooling circuit may be coupled to the main refrigeration system and be generally configured to subcool the refrigerant in the main refrigeration system. In some embodiments, the auxiliary subcooling circuit may include an auxiliary subcooling heat exchanger that can be coupled (e.g. thermally coupled) to the main refrigeration system. The auxiliary subcooling heat exchanger can be configured to receive two-phase refrigerant from the auxiliary subcooling circuit so as to subcool the refrigerant in the main refrigeration system. In some embodiments, the auxiliary subcooling heat exchanger may be coupled to the main refrigeration system between a condenser and an evaporator of the main refrigeration system. In some embodiments, the auxiliary subcooling heat exchanger may be coupled to the main refrigeration system upstream of the condenser. In some embodiments, the auxiliary subcooling circuit may direct two-phase refrigerant into a flash tank that is shared between the auxiliary subcooling circuit and the main refrigeration system, so as to subcool the refrigerant in the flash tank. A liquid portion of the refrigerant in the flash tank can be used in the main refrigeration system. In some embodiments, the auxiliary subcooling circuit and the main refrigeration system may be configured to be driven by a prime mover of the TRS. An engaging device can be configured to allow the auxiliary subcooling circuit to engage or disengage the prime mover, for example, on demand. The auxiliary subcooling heat exchanger may help increase efficiency of the main refrigeration system, and/or help the main refrigeration circuit to achieve, for example, a lower freezing temperature.

References are made to the accompanying drawings that form a part hereof, and in which is shown by way of illustration of the embodiments may be practiced. The terms “upstream” and “downstream” are referred relative to a refrigerant direction in a cooling mode. It is to be understood that the terms used herein are for the purpose of describing the figures and embodiments and should not be regarded as limiting the scope of the present application.

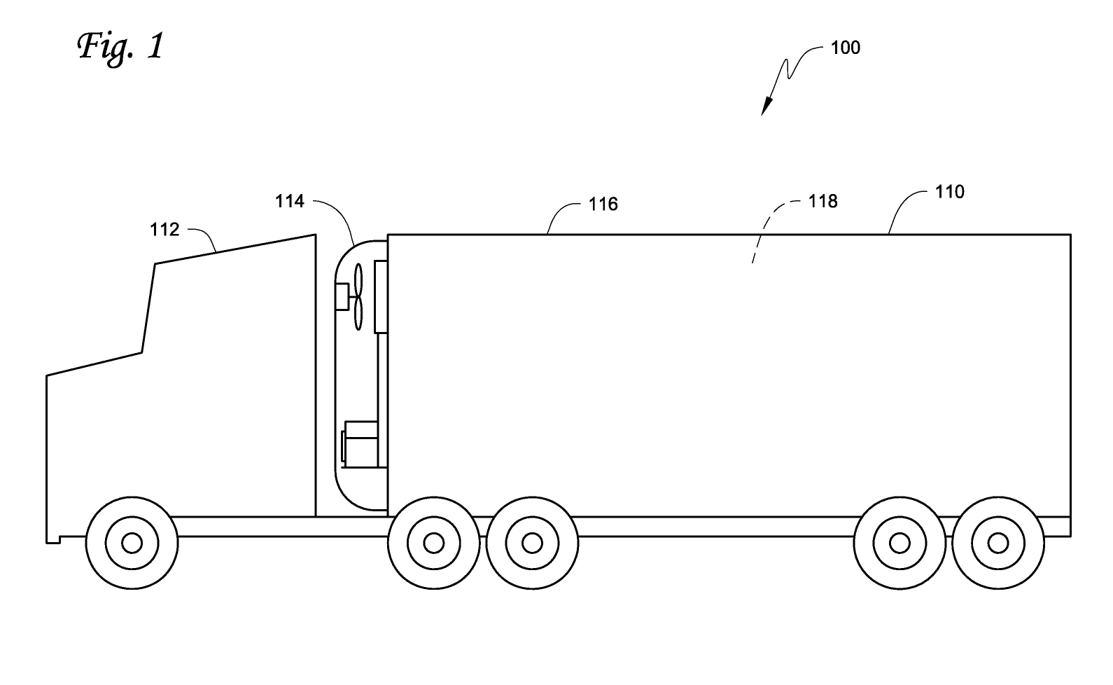

FIG. 1 illustrates a side view of a temperature controlled truck 100 including a refrigerated transport unit 110 that is towed by a tractor 112, with which the embodiments as described herein can be practiced. The refrigerated transport unit 110 includes a TRS 114 and a trailer 116. The TRS 114 is configured to be attached to a wall of the trailer 116, and is configured to control a temperature of an internal space 118 of the trailer 116.

While FIG. 1 illustrates the truck 100, it is to be understood that the embodiments as described herein can be used with other temperature controlled transport units, such as a shipping container, a railroad car, a temperature controlled truck, a passenger-carrying vehicle, etc. The embodiments as described herein can also be generally used with a refrigeration system that can benefit from subcooling the refrigerant.

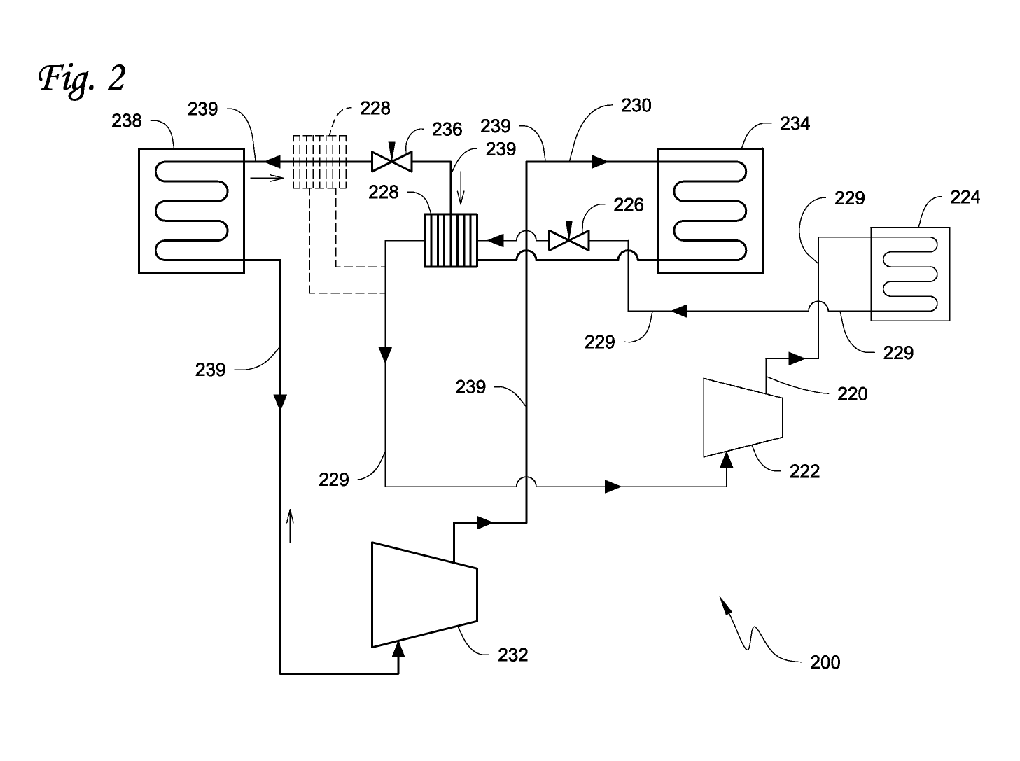

FIG. 2 illustrates one embodiment of a TRS 200, including an auxiliary subcooling circuit 220 that is coupled (e.g. thermally coupled) to a main refrigeration system 230. The main refrigeration system 230 includes a main compressor 232, a main condenser 234, a main expansion device 236 and a main evaporator 238, which are connected by main refrigerant lines 239 to form a refrigeration circuit. The term “thermally coupled” generally means that heat can be exchanged between the auxiliary subcooling circuit 220 (e.g. the refrigerant in the auxiliary subcooling circuit 220) and the main refrigeration system 230 (e.g. the refrigerant in the main refrigeration system 230).

The auxiliary subcooling circuit 220 includes an auxiliary compressor 222, an auxiliary condenser 224, an auxiliary expansion device 226 and an auxiliary subcooling heat exchanger 228, which are connected by auxiliary refrigeration lines 229. In the embodiment as shown in FIG. 2, the auxiliary subcooling circuit 220 is separate from the main refrigeration system 230 (i.e. the refrigerant in the auxiliary subcooling circuit 220 does not physically contact the refrigerant of the main refrigeration system 230.)

The auxiliary subcooling heat exchanger 228 is configured to be coupled to the main refrigeration system 230 between the main condenser 234 and the main expansion device 236, which is upstream of the main evaporator 238. The refrigerant in the main refrigeration system 230 can be subcooled before entering the main expansion device 236 and the main evaporator 238.

In operation, the block arrowheads illustrate flow directions of refrigerant in both the main refrigeration system 230 and the auxiliary subcooling circuit 220 in a cooling mode. In the main refrigeration system 230, a gaseous first refrigerant can be compressed by the main compressor 232. The compressed gaseous first refrigerant can flow to the main condenser 234 to be condensed into the liquid first refrigerant. The liquid first refrigerant can then flow to the main expansion device 236 to be expanded to two-phase first refrigerant, which also reduces a temperature of the first refrigerant. The two-phase first refrigerant can then flow into the main evaporator 238 to exchange heat, for example, with an internal space of a container (e.g. the internal space 118 of the container 116 as illustrated in FIG. 1) so as to cool the internal space of the container.

In the auxiliary subcooling circuit 220, a gaseous second refrigerant can be compressed by the auxiliary compressor 222, and then can flow into the auxiliary condenser 224 to be condensed into the liquid second refrigerant. The liquid second refrigerant can flow into the auxiliary expansion device 226 to be expanded to two-phase second refrigerant, which can also reduce the temperature of the refrigerant, and then can flow into the auxiliary subcooling heat exchanger 228.

In the embodiment as illustrated, the auxiliary subcooling heat exchanger 228 is thermally coupled to the main refrigerant system 230 between the main condenser 234 and the main expansion device 236. Generally, the two-phase second refrigerant in the auxiliary subcooling heat exchanger 228 has a lower temperature than the liquid first refrigerant in the main refrigerant system 230 between the main condenser 234 and the main expansion device 236. Therefore, the temperature of the liquid first refrigerant in the main refrigerant line 239 can be further lowered (or subcooled) by the two-phase second refrigerant in the auxiliary subcooling circuit 220 by heat exchange in the auxiliary subcooling heat exchanger 228.

Generally, a lower temperature of the liquid first refrigerant is associated with a lower enthalpy of the two-phase first refrigerant expanded by the main expansion device 236. As a result, the main evaporator 238, which receives the two-phase first refrigerant, may achieve a lower average coil temperature when the auxiliary subcooling circuit 220 is in operation. A lower average coil temperature of the evaporator 238 may help achieve a higher cooling capacity and/or efficiency, and/or achieve deeper freezing.

The main refrigeration system 230 may also be configured to work in a heating mode. The arrows in FIG. 2 illustrate the directions of the first refrigerant in the heating mode. In the heating mode, essentially the directions of the first refrigerant are reversed compared to the refrigerant direction in the cooling mode. The compressed gaseous first refrigerant can be directed to the main evaporator 238 first to release heat, for example, to the internal space of the container. The first refrigerant can then be directed into the main condenser 234 as two-phase first refrigerant through the main expansion device 236.

The auxiliary subcooling heat exchanger 228 may optionally be coupled to the main refrigerant system 230 between the main evaporator 238 and the main expansion device 236 to lower the temperature of the liquid first refrigerant entering the main expansion device 236 in the heating mode (as shown in FIG. 2 by dashed lines). Lowering the temperature of the liquid first refrigerant entering the main expansion device 236 can result in a lower temperature of the two-phase first refrigerant entering the main condenser 234 in the heating mode. This may help increase the efficiency of the main refrigeration system 234 in the heating mode when an ambient temperature surrounding the main condenser 234 is, for example, relatively low.

It is generally understood in the art that by using valves, such as for example a four-way valve or other types of valves (not shown), the auxiliary subcooling heat exchanger 228 may be configured to be coupled to different sections of the refrigerant lines 239 of the main refrigeration system 230 in the cooling mode and/or the heating mode. Therefore, the thermal coupling of the auxiliary subcooling circuit 220 to the main refrigeration system 230 in both the cooling mode and the heating mode can be realized by using the same auxiliary subcooling heat exchanger 228.

It is noted that in some embodiments, the first refrigerant and the second refrigerant may be the same type of refrigerant. In some embodiments, the first refrigerant and the second refrigerant may be different. By using different first refrigerant and the second refrigerant, the two refrigerants can be selected to satisfy different requirements. For example, the second refrigerant can be selected to have better saturation characteristics, better environmental characteristics (such as low Globe Warming Potentials), and/or lower costs.

It is also to be noted that the components of the main refrigeration system 230, such as the main compressor 232, the main condenser 234, etc., can be configured differently from the components of the auxiliary subcooling circuit 220. A cooling capacity of the main refrigeration system 230 can also be different from a cooling capacity of the auxiliary subcooling circuit 220. For example, the auxiliary subcooling circuit 220 may be configured to have less cooling capacity than the main refrigeration system 230. Therefore, manufacturing costs for the auxiliary subcooling circuit 220 may be lower than the costs for the main refrigeration system 230.

In some embodiments, the auxiliary condenser 224 and the main condenser 234 may be positioned to overlap with to each other, so that the same exhaust fan (not shown) can be shared by the auxiliary subcooling circuit 220 and the main refrigeration system 230 in the TRS 200.

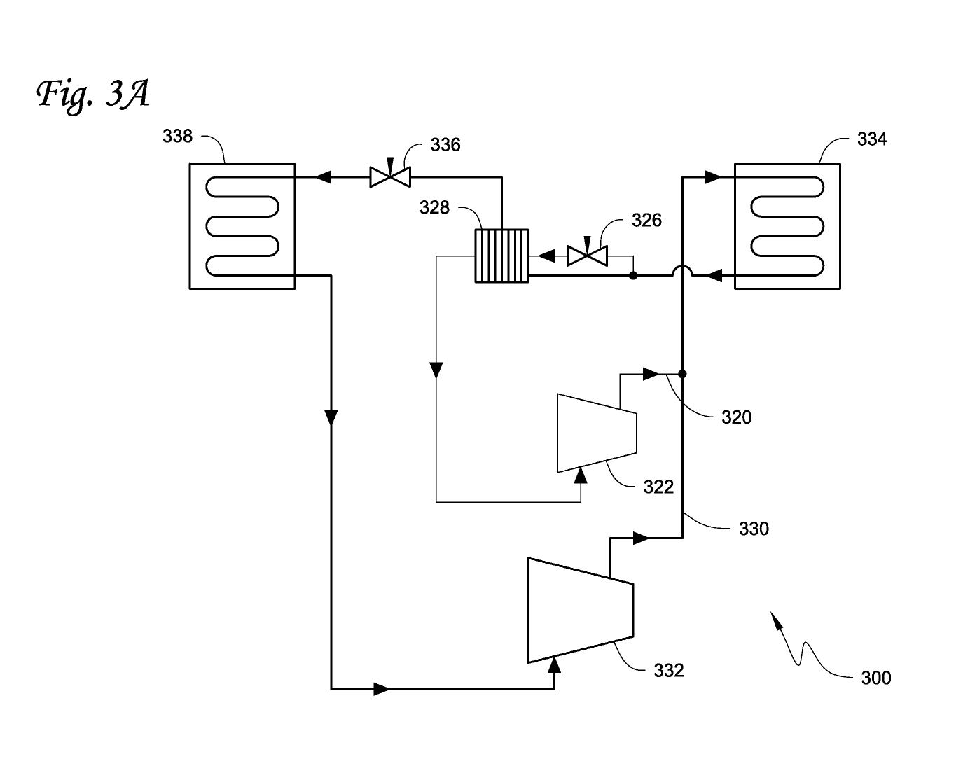

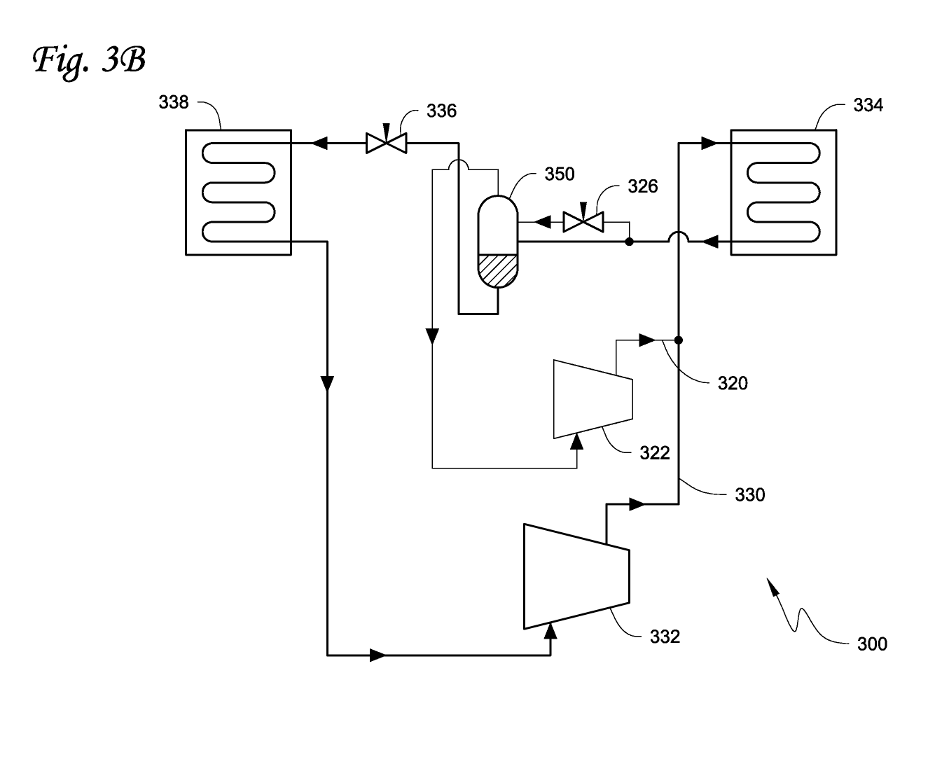

FIGS. 3A and 3B illustrate two embodiments of an auxiliary cooling circuit configured to subcool refrigerant in a main refrigeration system. In the illustrated embodiments of FIGS. 3A and 3B, the main refrigeration system and the auxiliary cooling circuit are not separate from each other, i.e. the refrigerant in the main refrigeration system is also used in the auxiliary cooling circuit. The subcooling of the refrigerant in the main refrigeration system generally happens upstream of a main expansion device of the main refrigeration system.

FIG. 3A illustrates one embodiment with a refrigeration system 300 including an auxiliary subcooling circuit 320 that is coupled (e.g. thermally coupled) to a main refrigeration system 330. The auxiliary subcooling circuit 320 includes an auxiliary compressor 322, an auxiliary expansion device 326 and an auxiliary subcooling heat exchanger 328. The main refrigeration system 330 includes a main compressor 332, a main expansion device 336 and a main evaporator 338. The auxiliary subcooling circuit 320 and the main refrigeration system 330 share a main condenser 334.

In the illustrated embodiment, the main refrigeration system 330 and the auxiliary subcooling circuit 320 are not separate from each other, i.e. the refrigerant in the main refrigeration system 330 is also used in the auxiliary subcooling circuit 320. In operation, refrigerant compressed by the main compressor 332 and the auxiliary compressor 322 are both directed to the main condenser 334. After being condensed by the main condenser 334, a portion of the liquid refrigerant is directed toward the main expansion device 336 and another portion of the liquid refrigerant is directed toward the auxiliary expansion device 326. In some embodiments, the portion of the liquid refrigerant directed to the auxiliary expansion device 326 is about 10 to about 25% of the total liquid refrigerant, with the appreciation that the range is merely exemplary.

Similar to the embodiment as described in FIG. 2, the portion of the liquid refrigerant expanded by the auxiliary expansion device 326 can exchange heat with the other portion of the liquid refrigerant directed toward the main expansion device 336 in the auxiliary subcooling heat exchanger 328 so as to reduce (or subcool) the temperature of the portion of the liquid refrigerant directed toward the main expansion device 336.

It is to be appreciated that generally, the auxiliary subcooling circuit (e.g. the auxiliary subcooling circuit 320) is configured to subcool the refrigerant that is directed toward the main expansion device (e.g. the main expansion device 336). FIGS. 2 and 3A illustrate embodiments that are configured to achieve the subcooling via an auxiliary heat exchanger. These embodiments are exemplary. Another way to subcool the refrigerant directed to the main expansion device is to mix the refrigerant with a relatively lower temperature from the auxiliary cooling circuit with the refrigerant directed toward the main expansion device.

FIG. 3B illustrates an embodiment that is configured to subcool the refrigerant of the main refrigeration system by mixing the refrigerant from the main refrigeration system 330 with a relatively low temperature refrigerant from the auxiliary subcooling circuit 320. Similar to FIG. 3A, the auxiliary subcooling circuit 320 and the main refrigeration system 330 share the condenser 334, with the understanding that this is exemplary. The auxiliary subcooling circuit 320 has the compressor 322 that is different from the main compressor 332 of the main refrigeration system 330.

As illustrated in FIG. 3B, both of the auxiliary subcooling circuit 320 and the main refrigeration system 330 direct refrigerant to a flash tank 350. In the auxiliary subcooling circuit 320, the refrigerant is expanded by the auxiliary expansion device 326 to lower the temperature of the refrigerant before entering the flash tank 350. In the main refrigeration system 330, the refrigerant is directed into the flash tank 350 without expansion from the condenser 334.

In the flash tank 350, the refrigerant with a relatively lower temperature from the auxiliary subcooling circuit 320 can be mixed with the refrigerant from the main refrigeration system 330, which helps subcool the temperature of the refrigerant from the main refrigeration system 330 upstream of the main expansion device 336 and the main evaporator 338.

In the flash tank 350, a gaseous portion of the refrigerant may be directed back to the auxiliary compressor 322 for compression. A liquid portion of the refrigerant may be directed into the main expansion device 336.

It is to be appreciated that the flash tank 350 is exemplary. The general principle is to mix the refrigerant with the relatively lower temperature from the auxiliary subcooling circuit 320 with the refrigerant from the main refrigeration system 330 so as to subcool the refrigerant directed to the main expansion device 336. After mixing the refrigerant, the gaseous portion of the refrigerant can be directed into the auxiliary subcooling circuit 320 while the liquid portion of the refrigerant can be directed into the main refrigeration system. Other devices (such as, for example, a liquid and gas separator) that can help mix the refrigerant from the auxiliary subcooling circuit 320 and the main refrigeration system 330 and/or help separate the gaseous portion and the liquid portion of the refrigerant may be suitable.

It is to be appreciated that the embodiments of the auxiliary subcooling circuit as described herein can be configured as a retro-fit kit to work with an existing refrigeration system. It is also to be appreciated that the embodiments as described herein can not only work with TRSs, but may also generally work with other refrigeration systems, such as, for example, a commercial refrigeration display case.

A TRS, such as the TRS 114 in FIG. 1, typically includes a prime mover (e.g. a compression-ignition (e.g. diesel) engine, a spark-ignition engine, an electric motor, etc.) to drive a compressor (e.g. the main compressor 232 in FIG. 2) of the TRS directly or indirectly. For TRSs equipped with an auxiliary subcooling circuit (e.g. the auxiliary subcooling circuit 220 in FIG. 2), the prime mover may be configured to drive both the main compressor and an auxiliary compressor (e.g. the auxiliary compressor 222 in FIG. 2) directly or indirectly.

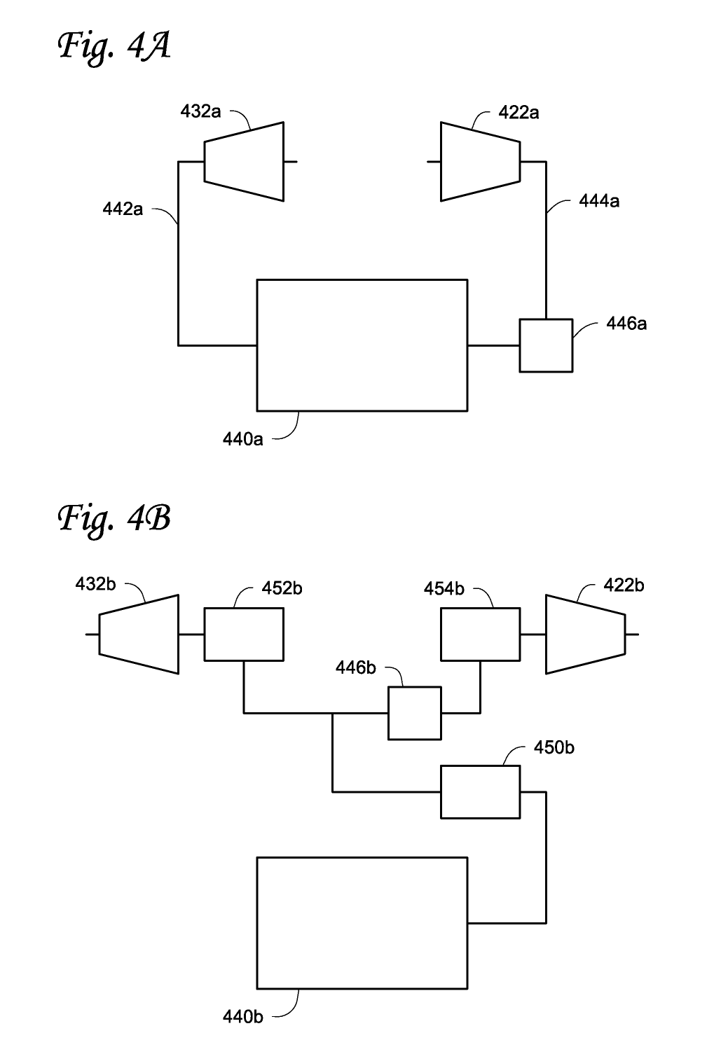

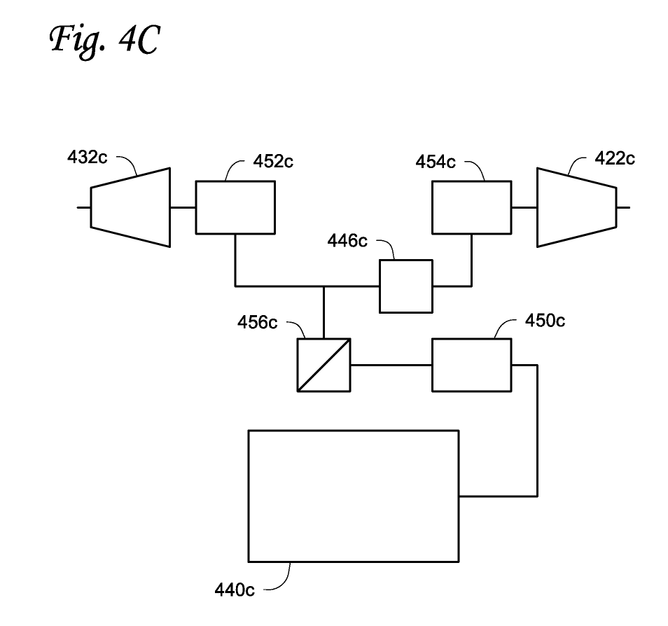

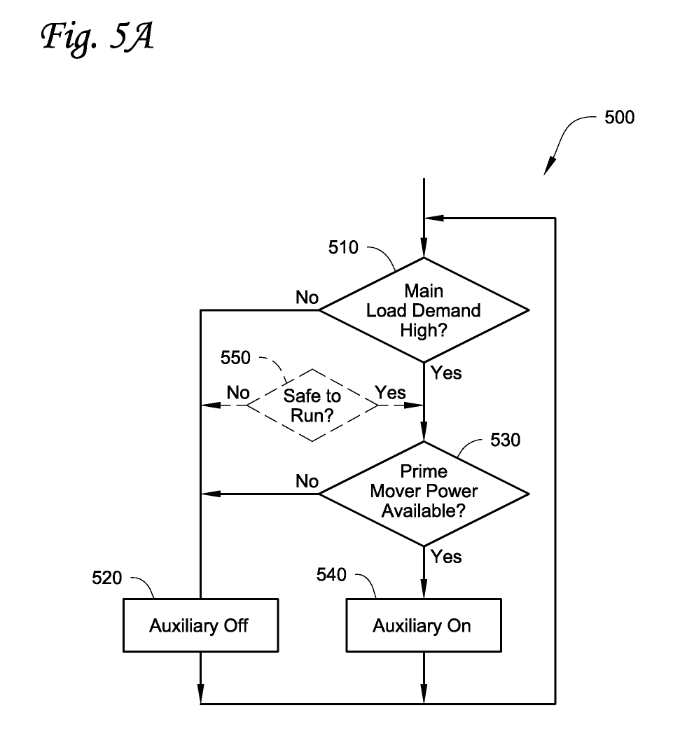

FIGS. 4A to 4C illustrate embodiments including prime movers 440a, 440b and 440c shared by main compressors 432a, 432b and 432c, and auxiliary compressors 422a, 422b and 422c respectively.

In FIG. 4A, the prime mover 440a is configured to mechanically drive the main compressor 432a directly by, for example, a first driving belt 442a. The auxiliary compressor 422a is also configured to be mechanically driven by the prime mover 440a via, for example, a second driving belt 444a. An engaging device 446a, such as for example a clutch, is configured to allow the second driving belt 444a to engage the prime mover 440a or disengage the second driving belt 444a from the prime mover 440a. By controlling the engaging device 446a, operation of the auxiliary compressor 422a can be turned on or off, for example, on demand.

FIG. 4B illustrates an embodiment that includes a generator 450b driven by the prime mover 440b. The generator 450b is configured to convert movements of the prime mover 440b into, for example, an AC current to power a first motor 452b and a second motor 454b. The first motor 452b is coupled to the main compressor 432b and the second motor 454b is coupled to the auxiliary compressor 422b. An engaging device 446b is configured to allow the second motor 454b to be coupled to (or engage) the generator 450b or disengage the second motor 454b from the generator 450b. By controlling the engaging device 446b, operation of the auxiliary compressor 422b can be turned on or off, for example, on demand. The engaging device 446b may be, for example, a mechanical switch or an electronically controlled switch. In this embodiment, the prime mover 440b is configured to drive the main compressor 432b and/or the auxiliary compressor 422b indirectly through electric coupling.

FIG. 4C illustrates an embodiment that includes an alternator 450c driven by the prime mover 440c. The alternator 450c is configured to convert movements of the prime mover 440c into, for example, a DC current. The embodiment also has an inverter 456c configured to convert the DC current to an AC current. The AC current can be used to power the first motor 452c and a second motor 454c that are coupled to the main compressor 432c and the auxiliary compressor 422c respectively. An engaging device 446c is configured to allow the second motor 454c to be coupled to (or engage) the inverter 456c or disengage from the inverter 456c. By controlling the engaging device 446c, operation of the auxiliary compressor 422c can be turned on or off, for example, on demand. The engaging device 446c may be, for example, a mechanical switch or an electronically controlled switch. In this embodiment, the prime mover is configured to drive the main compressor 432c and/or the auxiliary compressor 422c indirectly through electric coupling.

The embodiments as illustrated in FIGS. 4A to 4C are exemplary. Generally, the auxiliary compressor of the auxiliary subcooling circuit and the main compressor of the main refrigeration system can be powered by the prime mover directly, or indirectly by sharing electricity (e.g. an DC or AC current) generated by the alternator or the generator coupled to the prime mover. Operations of the auxiliary compressor can be configured to be turned on or off by the engaging device, so as to turn on or off an auxiliary subcooling circuit (e.g. the auxiliary subcooling circuit 220 in FIG. 2), for example, on demand. The engaging device can be configured to be manually controlled, or can be configured to be controlled by an electronic controller, such as a computer. The engaging device can allow the auxiliary subcooling circuit to be turned on or off on demand, for example, depending on operation requirements of the main refrigeration system.

In operation, advantages of the auxiliary subcooling circuit are typically more prominent when the load demand of the main refrigeration system is, for example, relatively high. The auxiliary subcooling circuit can typically be turned off when the load demand of the main refrigeration system is relatively low. However, it is noted that in some embodiments, the auxiliary subcooling circuit can be configured to be on regardless of the load demands of the main refrigeration system.

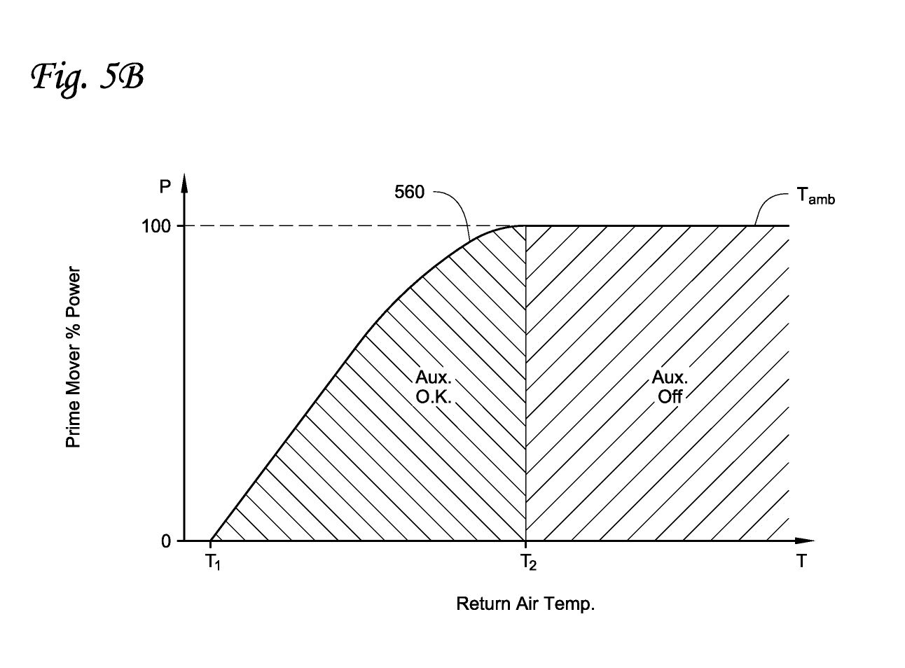

FIGS. 5A and 5B illustrate a method 500 to help determine whether to turn on or off an auxiliary subcooling circuit (such as the auxiliary subcooling circuit 220 in FIG. 2) in a TRS (such as the TRS 200 in FIG. 2) based on a load demand of the main refrigeration system (such as the main refrigeration system 230 in FIG. 2). The method 500 can be executed by controlling an engaging device (such as the engaging devices 446a, 446b and 446c in FIGS. 4A to 4C.) by, for example, a TRS controller (not shown).

At 510, the method 500 directs the controller to determine whether a load demand for a main refrigeration system is relatively high. In some embodiments, this can be determined, for example, by obtaining an operation speed of a prime mover (such as the prime movers 440a, 440b and 440c in FIGS. 4A to 4C). In some embodiments, the prime mover may be configured to have a low operation speed and a high operation speed. When the prime mover is operated at the low operation speed, the load demand for the main refrigeration system can be determined as relatively low (such as for example when the box temperature is below 4° C.). When the prime mover is operated at the high operation speed, the load demand for the main refrigeration may be determined as relatively high. Therefore, by obtaining the operation speed of the prime mover, the load demand for the main refrigeration system can be determined.

When the load demand for the main refrigeration system is relatively low, which can result in the prime mover to be operated at the low operation speed, the controller proceeds to 520. At 520, the auxiliary subcooling circuit is turned off or remains to be off.

The controller then proceeds back to 510 to allow the controller to determine whether the load demand for the main refrigeration system is relatively high. If the load demand of the main refrigeration system is determined to be relatively high at 510, the auxiliary subcooling circuit is permitted to be turned on. The controller then proceeds to 530 to determine whether the prime mover has power available to drive the auxiliary subcooling circuit.

It is noted that the load demand for the main refrigeration system can be determined by other ways, for example, by determining a difference between an ambient temperature and a temperature setpoint in an internal space of a container. The load of the main refrigeration may also be relatively high, when deep freezing (for example below −20° C.) in the internal space of the container is required. In some embodiments, for example, when the ambient temperature is above 80° C., or when the box temperature is above 30° C., the load of the main refrigeration system may also be relatively high.

At 530, the controller determines whether the prime mover has power available to drive the auxiliary subcooling circuit. If the prime mover does not have power available to drive the auxiliary subcooling circuit, the controller proceeds to 520 to prevent the auxiliary subcooling circuit from turning on or to keep the auxiliary subcooling circuit off. If the prime mover does have power available to drive the auxiliary subcooling circuit, the controller proceeds to 530 to turn on the auxiliary subcooling circuit or keep the auxiliary subcooling circuit on.

At 530, whether the prime mover has power available to drive the auxiliary subcooling circuit can be determined, for example, by determining a power demand of the main refrigeration system. Generally, when the power demand of the main refrigeration system is less than the maximum prime mover power, the prime mover may typically have power available to drive the auxiliary subcooling circuit.

FIG. 5B illustrates an exemplary power demand chart of the main refrigeration system that can be used at 530 to help determine the power demand of the main refrigeration system and whether the prime mover has power available to drive the auxiliary subcooling circuit.

Referring to FIG. 5B, a “T” axis represents a temperature of return air of an evaporator (such as the evaporator 238 in FIG. 2) of the main refrigeration system. The return air temperature typically corresponds to the temperature in the internal space of the container. A “P” axis represents a prime mover power demand by the main refrigeration system as a percentage of the maximum prime mover power.

Line 560 represents one exemplary power demand chart of the main refrigeration system when an ambient temperature is at a specific temperature: T_{amb} (such as for example about 30° C.). The line 560 indicates the power demand of the main refrigeration system corresponding to different return air temperatures. When the return air temperature is at T1 (e.g. the T1 is about a temperature setpoint of the internal space of the container), the main refrigeration system is stopped, and the power demand of the main refrigeration system is at about 0% of the maximum prime mover power. As shown in FIG. 5B, when the return air temperature rises above T1, the main refrigeration system starts to work. Generally, the more the return air temperature is raised from T1, the higher the power demand of the main refrigeration system is. At a temperature T2, the power demand of the main refrigeration system reaches about 100% of the maximum prime mover power. When the return air temperature is higher than T2, the power demand of the main refrigeration system remains at about 100% of the maximum prime mover power.

Generally, the auxiliary subcooling circuit has a less power demand than the main refrigeration system. For example, in one embodiment, the power demand for an auxiliary subcooling circuit is about 3 to 4 horsepower (HP), while the maximum prime mover power is about 34 HP. When the power demand of the main refrigeration system is less than 100%, it is possible that the prime mover can have enough power to drive both the main refrigeration system and the auxiliary subcooling circuit together, which allows the auxiliary subcooling circuit to be turned on.

Since FIG. 5B illustrates one exemplary power demand chart of the main refrigeration system, it can be used to determine whether the prime mover may have power available to drive the auxiliary subcooling circuit. In FIG. 5B, when the return air temperature is less than T2, it is permissible to turn on the auxiliary subcooling circuit because the main refrigeration system demand is less than the maximum prime mover power, which indicates that the prime mover may have power available to drive the auxiliary subcooling circuit. If the return air temperature is higher than T2, the prime mover generally reaches the maximum prime mover power and may generally not have sufficient power to drive the auxiliary subcooling circuit. Therefore, the auxiliary subcooling circuit generally is prevented from being turned on. By obtaining the return air temperature and using the power demand chart as illustrated in FIG. 5B, the method 500 can instruct the controller to predict and/or determine the power demand of the main refrigeration system in operation. Accordingly, the method 500 can help the controller to determine whether the prime mover has enough power to drive the auxiliary subcooling circuit in operation.

If the prime mover has enough power, the controller proceeds to 540 to turn on the auxiliary subcooling circuit or to keep the auxiliary subcooling circuit on. If the prime mover does not have enough power, the controller proceeds to 520 to turn off the auxiliary subcooling circuit or to keep the auxiliary subcooling circuit off.

It is to be understood that other methods can be used to determine whether the prime mover has enough power to drive the auxiliary subcooling circuit. For example, in an electronically governed engine, an engine control unit (ECU) can be configured to provide information regarding available power to determine whether the engine has enough power to drive the auxiliary subcooling circuit. In a mechanically governed (droop controlled) engine, changes of engine speed may be used to determine whether the engine has enough power to drive the auxiliary subcooling circuit. In an electrically driven system, current drawn by the electrical motor may be used to determine whether the electric motor has enough power to drive the auxiliary subcooling circuit. It is also possible to use the pressure differential between a suction line of the TRS and a discharge line of the TRS to determine the power of the compressor so as to determine whether the prime mover may have power available to drive the auxiliary subcooling circuit.

Referring to FIG. 5A, the controller then proceeds back to 510 to determine whether the main load demand of the main refrigeration system is relatively high.

The controller can also optionally include determining whether it is safe to operate the auxiliary subcooling circuit at 550. If it is safe to operate the auxiliary subcooling circuit at 550, the auxiliary subcooling circuit is then permitted to be turned on or kept on. Conversely, if it is not safe to operate the auxiliary subcooling circuit at 550, the auxiliary subcooling is generally prevented from turning on or to be turned off.

Operational parameters of the main refrigeration system and/or the auxiliary subcooling circuit can be used to determine whether it is safe to turn on the auxiliary subcooling circuit. For example, whether using the auxiliary subcooling circuit to subcool the refrigerant in the main refrigeration system will not damage the main refrigeration system and/or the auxiliary subcooling circuit may be a safety concern at 550. For example, at 550, the method may be configured to determine whether a refrigerant pressure in the main refrigeration system is higher than a safe operation requirement. If the refrigerant pressure is higher than the safe operation requirement, which indicates that it is not safe to operate the auxiliary subcooling circuit, the auxiliary subcooling circuit can be configured to be turned off or kept off. If the refrigerant pressure is lower than the safe operation requirement, which indicates that it is safe to operate the auxiliary subcooling circuit, the auxiliary subcooling circuit can be permitted to be turned on or kept on.

Other operational parameters of the main refrigeration system and/or the auxiliary subcooling circuit can also be used at 550 to determine whether it is safe to turn on the auxiliary subcooling circuit. The operation parameters, for example, may include an engine overheating temperature threshold, a low engine RPM threshold for engine operation, emission thresholds, and/or an engine overload threshold. Generally, if the method 500 determines that the operation parameters exceeds the thresholds, which may indicate that the engine is operated at an unsafe condition, the auxiliary subcooling circuit can be configured to be turned off or kept off.

The method 500 can help the controller determine whether to turn on the auxiliary subcooling circuit in a refrigeration system, such as a TRS. It is to be understood, however, methods that are different from the method 500 can also be configured to help the controller determine when to use the auxiliary subcooling circuit. A general principle to determine whether to use the auxiliary subcooling circuit in the TRS may be that the auxiliary subcooling circuit may be turned on when the main refrigeration system demand is relatively high, the prime mover has power available to drive the auxiliary subcooling circuit and it is safe to operate the auxiliary subcooling circuit.

### Comparative Experiment

A first TRS that is not equipped with an auxiliary subcooling circuit was compared to a second TRS that is equipped with an auxiliary subcooling circuit as described herein. The auxiliary subcooling circuit is coupled to a prime mover of the second TRS. A prime mover of the first TRS has about the same maximum power as the prime mover of the second TRS. In one experiment, a temperature of refrigerant entering an evaporator of the second TRS was about 25° C. lower than a temperature of refrigerant entering an evaporator of the first TRS. In another experiment, a maximum capacity of the second TRS was about 15% higher than the first TRS when the first and second TRS are operated at the maximum prime mover power.

### Aspects

It is noted that any of aspects 1-4 below can be combined with any of aspects 5-22. Any of aspects 5-19 can be combined with any of aspects 20-22.

Aspect 1. An auxiliary subcooling circuit for a transport refrigeration system comprising:

a compressor;

an expansion device; and

wherein the auxiliary refrigeration circus is configured to be coupled to a main refrigeration system of the transport refrigeration system so that refrigerant expanded by the expansion device is configured to reduce a temperature of refrigerant in the main refrigeration system before the refrigerant in the main refrigeration system is expanded by a main expansion device; and

the compressor of the auxiliary subcooling circuit is coupled to a prime mover of the transport refrigeration system.

Aspect 2. The auxiliary subcooling circuit of aspect 1 further comprising an auxiliary condenser.
Aspect 3. The auxiliary subcooling circuit of any of aspects 1-2 further comprising an auxiliary heat exchanger, wherein the auxiliary heat exchanger is configured so that the refrigerant expanded by the expansion device can exchange heat with the refrigerant in the main refrigeration system.
Aspect 4. The auxiliary subcooling circuit of any of aspects 1-3 further comprising a flash tank, wherein the flash tank is configured so that the refrigerant expanded by the expansion device can exchange heat with the refrigerant in the main refrigeration system.
Aspect 5. A transport refrigeration system comprising:

a main refrigeration system including:
a main compressor; and
a main expansion device;

an auxiliary subcooling circuit including:
an auxiliary compressor; and
an auxiliary expansion device; and

a prime mover;

wherein the prime mover is configured to drive the main compressor and the auxiliary compressor.

Aspect 6. The transport refrigeration system of aspect 5, wherein the auxiliary subcooling circuit is coupled to the main refrigeration system so that refrigerant expanded by the auxiliary expansion device is configured to reduce a temperature of refrigerant in the main refrigeration system before the refrigerant in the main refrigeration system is expanded by a main expansion device.
Aspect 7. The transport refrigeration system of any of aspects 5-6, wherein the auxiliary subcooling circuit and the main refrigeration system are coupled through a heat exchanger.
Aspect 8. The transport refrigeration system of any of aspects 5-7, wherein the auxiliary subcooling circuit and the main refrigeration system are coupled through a flash tank.
Aspect 9. The transport refrigeration system of any of aspects 5-8, wherein the prime mover is coupled to the auxiliary compressor through an engaging device that is configured to have an engaging status and a disengaging status,

when the engaging device is in the engaging status, the auxiliary compressor is driven by the prime mover, and when the engaging device is in the disengaging status, the auxiliary compressor is disengaged from the prime mover.

Aspect 10. The transport refrigeration system of any of aspects 5-9, wherein the engaging device is a clutch member.
Aspect 11. The transport refrigeration system of any of aspects 5-10, wherein the refrigerant in the auxiliary subcooling circuit is separate from the main refrigeration system.
Aspect 12. The transport refrigeration system of any of aspects 5-11, wherein the auxiliary subcooling refrigeration circuit is coupled to a refrigeration line of the main refrigeration system upstream of the main expansion device.
Aspect 13. A method of controlling the transport refrigeration system of any of aspects 5-12,

wherein the prime mover has a high speed operation mode and a low speed operation mode.

Aspect 14. The method of aspect 13, further comprising when the prime mover is at the high speed operation mode, permitting the auxiliary subcooling circuit to be turned on.
Aspect 15. The method of any of aspects 13-14, further comprising:

when the prime mover is at the low speed operation mode, preventing the auxiliary subcooling circuit from being turned on.

Aspect 16. The method of any of aspects 13-15, further comprising:

determining whether the prime mover has power available to drive the auxiliary subcooling circuit;

when the prime mover has the power available to drive the auxiliary subcooling circuit, turning on the auxiliary subcooling circuit; and

when the prime mover does not have the power available to drive the auxiliary subcooling circuit, turning off the auxiliary subcooling circuit.

Aspect 17. The transport refrigeration system of any of aspects 5-16, wherein the main refrigeration system and the auxiliary subcooling circuit are both configured to direct refrigerant into a main condenser.
Aspect 18. The transport refrigeration system of any of aspects 5-17, further comprising an alternator coupled to the prime mover;

wherein the engaging device is configured to be coupled to the alternator.

Aspect 19. The transport refrigeration system of any of aspects 5-18, further comprising a generator coupled to the prime mover;

wherein the engaging device is configured to be coupled to the generator.

Aspect 20. A method of subcooling a refrigerant of a main refrigeration system of a transport refrigeration system comprising:

directing a portion of power of a prime mover to a first refrigeration system to reduce a temperature of first refrigerant in a first refrigeration circuit; and

reducing a temperature of second refrigerant in a second refrigeration circuit with the first refrigerant, wherein the second refrigeration circuit is driven by another portion of the power of the prime mover.

Aspect 21. The method of aspect 20 further comprising:

determining whether the prime mover has power available to drive the first refrigeration system; and

when the prime mover has the power available to drive the first refrigeration system, directing a portion of power of the prime mover to the first refrigeration system.

Aspect 22. The method of any of aspects 20-21 further comprising:

determining whether the prime mover has power available to drive the first refrigeration system; and

when the prime mover has no power available to drive the first refrigeration system, preventing a portion of power of the prime mover being directed to the first refrigeration system.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered

What claimed is:

1. An auxiliary subcooling circuit for a transport refrigeration system comprising:
a compressor;
an expansion device; and
wherein the auxiliary refrigeration circus is configured to be coupled to a main refrigeration system of the transport refrigeration system so that refrigerant expanded by the expansion device is configured to reduce a temperature of refrigerant in the main refrigeration system before the refrigerant in the main refrigeration system is expanded by a main expansion device; and
the compressor of the auxiliary subcooling circuit is coupled to a prime mover of the transport refrigeration system.

2. The auxiliary subcooling circuit of claim 1 further comprising an auxiliary condenser.

3. A transport refrigeration system comprising:
a main refrigeration system including:
a main compressor; and
a main expansion device;
an auxiliary subcooling circuit including:
an auxiliary compressor; and
an auxiliary expansion device; and
a prime mover;
wherein the prime mover is configured to drive the main compressor and the auxiliary compressor.

4. The transport refrigeration system of claim 3, wherein the auxiliary subcooling circuit is coupled to the main refrigeration system so that refrigerant expanded by the auxiliary expansion device is configured to reduce a temperature of refrigerant in the main refrigeration system before the refrigerant in the main refrigeration system is expanded by a main expansion device.

5. The transport refrigeration system of claim 3, wherein the auxiliary subcooling circuit and the main refrigeration system are coupled through a heat exchanger.

6. The transport refrigeration system of claim 3, wherein the prime mover is coupled to the auxiliary compressor through an engaging device that is configured to have an engaging status and a disengaging status,
when the engaging device is in the engaging status, the auxiliary compressor is driven by the prime mover, and when the engaging device is in the disengaging status, the auxiliary compressor is disengaged from the prime mover.

7. The transport refrigeration system of claim 4, wherein the engaging device is a clutch member.

8. The transport refrigeration system of claim 3, wherein the refrigerant in the auxiliary subcooling circuit is separate from the main refrigeration system.

9. The transport refrigeration system of claim 3, wherein the auxiliary subcooling refrigeration circuit is coupled to a refrigeration line of the main refrigeration system upstream of the main expansion device.

10. A method of controlling the transport refrigeration system of claim 9,
wherein the prime mover has a high speed operation mode and a low speed operation mode.

11. The method of claim 9, further comprising
when the prime mover is at the high speed operation mode, permitting the auxiliary subcooling circuit to be turned on.

12. The method of claim 9, further comprising:
when the prime mover is at the low speed operation mode, preventing the auxiliary subcooling circuit from being turned on.

13. The method of claim 9, further comprising:
determining whether the prime mover has power available to drive the auxiliary subcooling circuit;
when the prime mover has the power available to drive the auxiliary subcooling circuit, turning on the auxiliary subcooling circuit; and
when the prime mover does not have the power available to drive the auxiliary subcooling circuit, turning off the auxiliary subcooling circuit.

14. The transport refrigeration system of claim 3, wherein the main refrigeration system and the auxiliary subcooling circuit are both configured to direct refrigerant into a main condenser.

15. The transport refrigeration system of claim 4, further comprising an alternator coupled to the prime mover;
wherein the engaging device is configured to be coupled to the alternator.

16. The transport refrigeration system of claim 4, further comprising a generator coupled to the prime mover;
wherein the engaging device is configured to be coupled to the generator.

17. A method of subcooling a refrigerant of a main refrigeration system of a transport refrigeration system comprising:
directing a portion of power of a prime mover to a first refrigeration system to reduce a temperature of first refrigerant in a first refrigeration circuit; and
reducing a temperature of second refrigerant in a second refrigeration circuit with the first refrigerant, wherein the second refrigeration circuit is driven by another portion of the power of the prime mover.

18. The method of claim 17 further comprising:
determining whether the prime mover has power available to drive the first refrigeration system; and
when the prime mover has the power available to drive the first refrigeration system, directing a portion of power of the prime mover to the first refrigeration system.

19. The method of claim 17 further comprising:
determining whether the prime mover has power available to drive the first refrigeration system; and
when the prime mover has no power available to drive the first refrigeration system, preventing a portion of power of the prime mover being directed to the first refrigeration system.
